(19) United States
(12) Patent Application Publication
(10) Pub. No.: US 2006/0171746 A1
(43) Pub. Date: Aug. 3, 2006

(54) Developing method, developing device, and image forming device

(75) Inventor: Takuya Goto, Tokyo (JP)

Correspondence Address: TAKEUCHI & KUBOTERA, LLP, Suite 202, 200 Daingerfield Road, Alexandria, VA, 22314, US

(73) Assignee: Oki Data Corporation

(21) Appl. No.: 11/334,484

(22) Filed: Jan. 19, 2006

(30) Foreign Application Priority Data
Jan. 31, 2005 (JP) 2005-023853

(51) Int. Cl. G03G 15/08

(52) U.S. Cl. 399/284

(57) ABSTRACT

A developing device includes a developer support member for supplying developer to an image supporting member to form a static latent image; a developer supplying member for charging the developer and supplying the developer to the developer support member; and a layer controlling member abutting against the developer supply member for forming a thin layer of the developer. The layer controlling member is arranged such that the layer controlling member contacts with the developer supporting member with a contact pressure P (g/cm) according to a specific relationship relative to D and |Q|, wherein D represents a volume average particle diameter (μm) of the developer, and |Q| represents an absolute value of an average charge amount Q (μC/g) of the developer on the developer support member before the developer passes through the layer controlling member. The volume average particle diameter D is within a range of
5.2 μm≦D≦9.8 μm.

### BACKGROUND OF THE INVENTION

The present invention relates to a developing device and an image forming device having the developing device. The present invention also relates to a method of developing a static latent image.

A conventional image forming device of an electric photography type such as a printer, a copier, and a facsimile forms an image through recording processes such as a charging process, an exposure process, a developing process, a transfer process, and a cleaning process. In the developing process, a contact-type developing device is used utilizing toner containing a non-magnetic component.

Such a developing device includes a developing roller adapted to contact with a photosensitive drum; a toner supply roller adapted to contact with the developing roller; and a layer controlling blade. The toner supply roller supplies toner to the developing roller. The layer controlling blade forms a thin toner layer on the developing roller. The developing roller is charged with a voltage, and toner is attached to a static latent image formed on the photosensitive drum to form a toner image.

When a printer prints a large number of sheets, an average size of toner remaining in the developing device tends to increase, thereby deteriorating image quality. In a developing device disclosed in Japanese Patent Publication No. 07-92798, it is proposed that a developing roller is pressed against a layer controlling blade according to the following equation to prevent an average size of toner from increasing.
Dt≦15
20≦P≦−16.44×Dt+243.5
where Dt is a volume average particle diameter of toner (μm), and P (g/cm) is a pressure of the developing roller against the layer controlling blade.

In the developing device disclosed in Japanese Patent Publication No. 07-92798, when the developing roller is pressed against the layer controlling blade according to the above equation, it is difficult to obtain a thin toner layer on the developing roller, thereby causing smear of an image and deteriorating image quality. Further, it is difficult to pass a sufficient amount of toner through the layer controlling blade, thereby decreasing darkness of an image and deteriorating image quality.

In view of the problems described above, an object of the present invention is to provide a developing device and an image forming device, in which a layer of developer on a developer supporting member is stabilized after the developer passes through a layer controlling blade. Accordingly, it is possible to secure sufficient darkness of an image without causing smear on the image due to leaking of the developer.

Further objects and advantages of the invention will be apparent from the following description of the invention.

### SUMMARY OF THE INVENTION

In order to attain the objects described above, according to the present invention, a developing device or an image forming apparatus comprises a developer support member for supplying developer to an image supporting member to form a static latent image; a developer supplying member for charging the developer and supplying the developer to the developer support member; and a layer controlling member abutting against the developer supply member for forming a thin layer of the developer. When D (μm) represents a volume average particle diameter of the developer, Q (μC/g) represents an average charge amount of the developer before passing through the layer controlling member, and P (g/cm) represents a contact pressure of the developer supporting member against the layer controlling member, the following relation is established.
5.2≦D≦10.0

Further, P has a specific relationship relative to D and an absolute value of Q.

With the configuration described above, it is possible to stabilize a layer of the developer on the developer supporting member after the developer passes through the layer controlling member. Accordingly, it is possible to secure sufficient darkness of an image without causing smear on the image due to leaking of the developer.

### BRIEF DESCRIPTION OF THE DRAWINGS

FIGS. 1(a) and 1(b) are schematic views showing a developing device according to a first embodiment of the present invention, wherein FIG. 1(a) is a schematic view showing an overall structure of the developing device, and FOG. 1(b) is an enlarged view showing a contact point between a developing roller and a layer controlling blade;

FIG. 2 is a schematic view showing a printer according to the first embodiment of the present invention;

FIG. 3 is a table showing experimental results according to the first embodiment of the present invention;

FIGS. 4(a) and 4(b) are schematic views showing a developing device according to a second embodiment of the present invention, wherein FIG. 4(a) is a schematic view showing an overall structure of the developing device, and FIG. 4(b) is an enlarged view showing a contact point between a developing roller and a layer controlling blade;

FIG. 5 is a schematic view showing a printer according to the second embodiment of the present invention; and

FIG. 6 is a table showing experimental results according to the second embodiment of the present invention.

### DETAILED DESCRIPTION OF THE PREFERRED EMBODIMENTS

Hereunder, embodiments of the present invention will be explained with reference to the accompanying drawings. In the embodiments, an image forming apparatus is a color printer of an electric photography type.

### First Embodiment

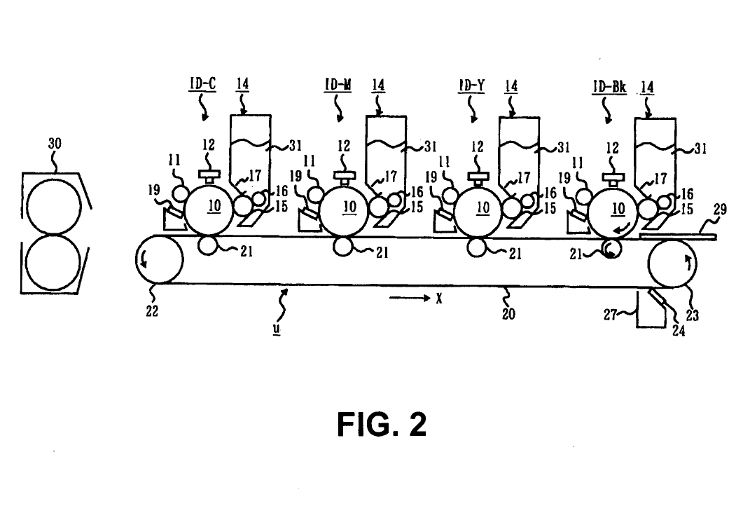

FIG. 2 is a schematic view showing the printer according to the first embodiment of the present invention. As shown in FIG. 2, image forming units ID-Bk (black), ID-Y (yellow), ID-M (magenta), and ID-C (cyan) are disposed in this order from an upstream side in a direction that a sheet 29 as a recording medium is transported. LED heads 12 as an exposure device and a transfer unit u are disposed to face the image forming units ID-Bk, ID-Y, ID-M, and ID-C.

The image forming units ID-Bk, ID-Y, ID-M, and ID-C have a same structure, and a structure of the image forming unit ID-Bk will be explained in detail as an example. In the image forming unit ID-Bk, a photosensitive drum 10 is provided as an organic photosensitive member and an image supporting member. A charging roller 11 as a charging device; the LED head 12; a developing unit 14 as a developing device; and a cleaning blade 19 as a cleaning device for the image supporting member are disposed around the photosensitive drum 10.

The developing unit 14 is provided with a developing roller 15 as a developer supporting member. The developing unit 14 is further provided with a layer controlling blade 17 as a layer controlling member for forming a thin layer of toner 31 as developer containing a non-magnetic component. The layer controlling blade 17 is adapted to contact with the developing roller 15 to form a thin layer of the toner 31 on the developing roller 15. The developing unit 14 is adapted to contact with the developing roller 15, and includes a toner supplying roller 16 as a developer supplying member for supplying toner to the developing roller 15.

The cleaning blade 19 is adapted to contact with the photosensitive drum 10. A power supply (not shown) supplies a direct current voltage to the charging roller 11, the developing roller 15, and the toner supplying roller 16. The charging roller 11 charges a surface of the photosensitive drum 10 uniformly. The LED head 12 irradiates light corresponding to an image signal on the surface of the photosensitive drum 10 thus charged to form a static latent image. The LED head 12 may have a combined structure of an LED array and a rod array lens. The LED head 12 also has a function of changing an exposure time to adjust an exposure amount.

The transfer unit u is pressed against the photosensitive drums 10 with a specific pressure. The transfer unit u is provided with an endless transfer belt 20 moving in an arrow direction X as a transport member or a transfer member to transport the sheet 29. The transfer unit u is adapted to face the photosensitive drums 10 with the transfer belt 20 in between. The transfer unit u is further provided with transfer rollers 21 as a transfer device applied with a transfer voltage. The transfer unit u is further provided with a drive roller 22 and a follower roller 23 for moving the transfer belt 20. The transfer unit u is further provided with a drive motor (not shown) as a drive unit for rotating the drive roller 22.

A toner image on the photosensitive drum 10 as a developing image is transferred to the sheet 29 passing between the photosensitive drum 10 and the transfer roller 21. A transfer unit is formed between each of the photosensitive drums 10 and the transfer rollers 21. After the toner image is transferred, the cleaning blade 19 scrapes off the toner 31 remaining on the photosensitive drum 10, so that the toner 31 is removed from the photosensitive drum 10 and collected. A cleaning blade 24 is disposed at a downstream side of the transfer belt 20 as a cleaning device of the transfer device, so that the cleaning blade 24 scrapes off the toner 31 on the transfer belt 20. After the toner 31 is removed from the transfer belt 20 and collected, the toner 31 is retained in a waste toner box 27.

A fixing device 30 is disposed at a downstream side in the direction that the sheet 29 is transported. The fixing device 30 fixes the toner image as a developing image in color on the sheet 29 discharged from the transfer unit u, so that a color image as an image in color is formed. Afterwards, the sheet 29 is discharged with a discharge roller (not shown) from the printer.

An operation of the printer having the structure described above will be explained next. When a control unit (not shown) receives a print command from an upper device (not shown) such as a personal computer, the control unit controls the drive unit to rotate the photosensitive drums 10 at a constant circumference speed. In the charging process, the charging rollers 11 are pressed against and contact with the surfaces of the photosensitive drums 10. A direct current voltage is applied to the charging rollers 11, so that the charging rollers 11 charge the surfaces of the photosensitive drums 10 uniformly. In the exposure process, the LED heads 12 irradiate light corresponding to an image signal on the photosensitive drums 10 to form static latent images.

The toner supply rollers 16 rotate to supply the toner 31 retained in the developing units 14 to the developing rollers 15. At this time, a high voltage power source (not shown) applies a voltage to the toner supplying rollers 16. Accordingly, the toner 31 is charged through friction against the toner supplying rollers 16, friction against the developing rollers 15, and a potential difference between the toner supplying rollers 16 and the developing rollers 15. The developing rollers 15 absorb and transport the toner 31. The layer controlling blades 17 are disposed at a downstream side in a direction that the developing rollers 15 rotate, and contact with the developing rollers 15 for forming a toner layer as a developer layer having a constant thickness.

In the developing process, the developing rollers 15 develop the static latent images formed on the photosensitive drums 10 to form toner images as developing images in each of black, yellow, magenta, and cyan. In the embodiment, reverse developing is performed. A high voltage power source (not shown) applies a bias voltage between conductive support members of the photosensitive drums 10 and the developing rollers 15. With such a structure, static electricity corresponding to the static latent images formed on the photosensitive drums 10 is generated between the developing rollers 15 and the photosensitive drums 10. Accordingly, the toner 31 thus charged on the developing rollers 15 is stick to the photosensitive drums 10 with the static electricity.

Then, the drive roller 22 and the follower roller 23 rotate to move the transfer belt 20 in the arrow direction X. The transfer belt 20 transports the sheet 29 supplied from a sheet supply tray (not shown) to each of the transfer units of black, yellow, magenta, and cyan. In the transfer process, a high voltage power source (not shown) applies a voltage to the transfer rollers 21 facing the photosensitive drums 10. In the transfer units, toner images of black, yellow, magenta, and cyan are sequentially transferred to the sheet 29 to form the toner image in color.

Afterwards, the transfer belt 20 further transports the sheet 29 to the fixing device 30, so that the toner image in color is fixed to the sheet 29 to form a color image. At this time, the toner 31 is melt with heat and pressure, and penetrates into fibers of the sheet 29. After forming the color image, the sheet 29 is discharged outside the printer. A small amount of the toner 31 may remain on the photosensitive drums 10 after the transfer process. In the cleaning process, the cleaning blades 19 remove the remaining toner 31, so that the photosensitive drums 10 can be used repeatedly.

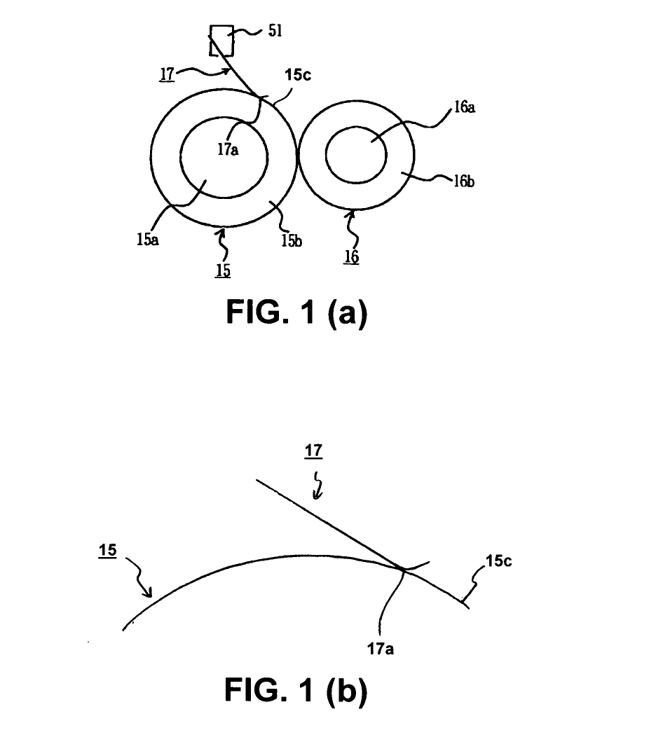

A configuration of the developing device will be explained next. FIGS. 1(a) and 1(b) are schematic views showing the developing device according to the first embodiment of the present invention. FIG. 1(a) is a schematic view showing an overall structure of the developing device, and FIG. 1(b) is an enlarged view showing a contact point between the developing roller 15 and the layer controlling blade 17.

As shown in FIG. 1(a), the developing roller 15 includes a metal shaft 15a and an elastic member 15b disposed on an outer surface of the shaft 15a. A coat layer may be formed on a surface of the elastic member 15b for increasing frictional charging characteristic relative to the toner 31 (FIG. 2). Alternatively, the surface of the elastic member 15b may be chemically processed (specific functional groups may be chemically attached to the surface of the elastic member 15b).

In the embodiment, the shaft 15a is formed of a metal shaft with a diameter of 12 mm. The elastic member 15b is formed of a semi-conductive urethane rubber with a thickness of 4 mm and a rubber hardness of 70° (ASKER C). A surface layer 15c of the elastic member 15b is processed with isocyanate for improving the charging characteristic relative to the toner 31.

The toner supply roller 16 includes a metal shaft 16a and a foam member 16b disposed on an outer surface of the shaft 16a. In the embodiment, the shaft 16a is formed of a metal shaft with a diameter of 6 mm. The foam member 16b has a thickness of 5 mm and a hardness of 50° (ASKER F).

The layer controlling blade 17 is formed of stainless steel (SUS 304) with elasticity, and has a thickness of 0.08 mm. The layer controlling blade 17 includes a portion formed in an L-shape and abutting against the developing roller 15. As shown in FIG. 1(b), the layer controlling blade 17 is arranged such that an edge portion 17a of the L-shaped portion is pressed against the surface layer 15c (outermost layer of the developing roller 15). In the embodiment, the layer controlling blade 17 is arranged such that the developing roller 15 is pressed with a pressure in the range of 5 to 200 g/cm, in which the pressure is expressed as a linear pressure (load per length in a width direction).

The developing device is further provided with a contact pressure control unit 51 for controlling the contact pressure of the layer controlling member against the developer supporting member. The contact pressure control unit 51 may include a structure such as a mechanical adjusting unit and an electrical adjusting unit.

The toner 31 contains polyester as a tackifier resin. The toner 31 also contains carbon black, C. I. Pigment Yellow 185, Quinacridne-type dye (C. I. Pigment Red 122), and copper phthalocyanine dye (C. I. Pigment Blue 15) as colorants of black, yellow, magenta, and cyan, respectively. The toner 31 has a volume average particle size of 5.2 μm, 7.6 μm, 8.5 μm, and 9.8 μm, respectively. The toner 31 further contains, as outside additives, a flow promoter and silica with charging characteristic for controlling the charging characteristic of the toner 31.

An experiment of finding an optimal range of a contact pressure will be explained next. In the experiment, a volume average particle diameter D (μm) of the toner 31 and a contact pressure P (g/cm) of the layer controlling blade 17 were changed. In the optimal range, there is no smear in printing a white sheet, and a darkness of 1.2 or higher is obtained in printing a whole black sheet, i.e., 100% darkness. A darkness meter (X-Rite 504 of Nippon Heiban-sha) was used for measuring the darkness.

In the experiment, the charging characteristic of silica contained in the toner 31 as the outside additive; a pressure between the toner supplying roller 16 and the developing roller 15; and a voltage applied to the toner supplying roller 16 were also changed. With these changes, it was possible to change an average charge amount Q (μC/g) of the toner 31 on the developing roller 15 situated at a downstream side of the toner supplying roller 16 and an upstream side of the layer controlling blade 17. A q/m meter (210HS of Trek Inc.) and a precision balance (AUW120D of Shimadzu Corp.) were used for measuring the average charge amount Q (μC/g) of the toner 31.

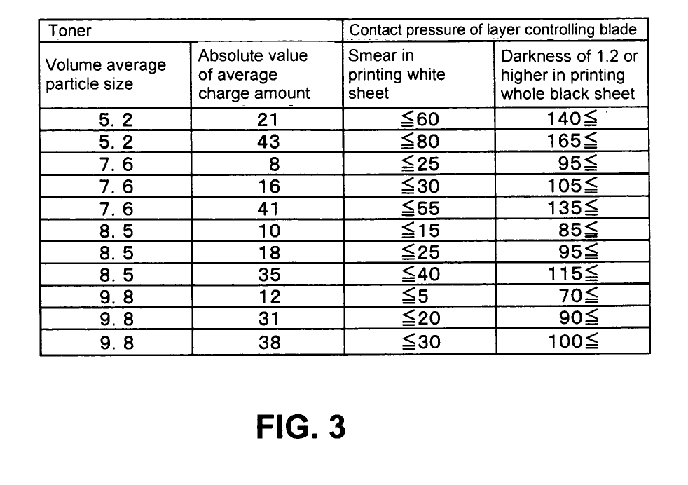

In the measurement, first, the toner 31 in the developing unit 14 was taken out through gravity. The toner 31 on the developing roller 15 after passing through the toner supplying roller 16 and before passing through the layer controlling blade 17 was suctioned with the q/m meter, and an amount of charge was measured. Then, a weight of the toner 31 thus suctioned was measured with the precision balance to determine the average charge amount Q (μC/g) of the toner 31. FIG. 3 is a table showing experimental results according to the first embodiment of the present invention.

Note that a very fine image has been required lately, and it is difficult to obtain a good image with toner having a volume average particle diameter greater than 10 μm. On the other hand, when toner having a volume average particle diameter less than 5.2 μm, the toner tends to leak from the developing device due to the small size. Further, it is difficult to manufacture fine size toner with low cost. Therefore, in the experiment, toner having a volume average particle diameter smaller than 10 μm and greater than 5.2 μm was used.

As shown in FIG. 3, when the volume average particle diameter D (μm) of the toner 31 and an absolute value |Q| of the average charge amount Q (μC/g) are fixed, the contact pressure P (g/cm) of the layer controlling blade 17 has a lower limit where there is no smear in printing a white sheet and an upper limit where a darkness of 1.2 or higher is obtained in printing a whole black sheet. For example, when the volume average particle diameter D of the toner 31 was 5.2 μm and the the absolute value |Q| of the average charge amount Q was 21 μC/g, there was smear in printing a white sheet when the contact pressure P of the layer controlling blade 17 was less than 60 g/cm. However, there was no smear in printing a white sheet when the contact pressure P of the layer controlling blade 17 was greater than 60 g/cm. The darkness of 1.2 or lower was obtained in printing a whole black sheet when the contact pressure P of the layer controlling blade 17 was greater than 140 g/cm. However, the darkness of 1.2 or higher was obtained in printing a whole black sheet when the contact pressure P of the layer controlling blade 17 was smaller than 140 g/cm.

As shown in FIG. 3, when the volume average particle diameter D of the toner 31 decreases or the absolute value |Q| of the average charge amount Q increases, it is necessary to increase the contact pressure P of the layer controlling blade 17 for preventing smear on a white sheet. In contrast, when the volume average particle diameter D of the toner 31 increases or the absolute value |Q| of the average charge amount Q decreases, it is necessary to decrease the contact pressure P of the layer controlling blade 17 for obtaining a sufficient darkness in 100% printing.

Through the multiple regression analysis, a regression equation of the optimal range of the contact pressure P of the layer controlling blade 17 is obtained relative to the volume average particle diameter D of the toner 31 and the absolute value |Q| of the average charge amount Q as follows:
93.89−10.23×D+0.93×|Q|<P<184.91−13.09×D+1.15×|Q|

It is found that the regression equation has a contribution of 0.99, indicating high reliability.

Accordingly, in the embodiment, the contact pressure P of the layer controlling blade 17 is adjusted to be in the following range:
93.89−10.23×D+0.93×|Q|<P<184.91−13.09×D+1.15×|Q|
where D represents the volume average particle diameter of the toner 31, and |Q| represents the absolute value of the average charge amount Q of the toner 31 on the developing roller 15 before passing through the layer controlling blade 17. With the adjustment, a layer of the toner on the developing roller 15 is stabilized after passing through the layer controlling blade 17. Accordingly, it is possible to secure sufficient darkness of an image without causing smear on the image due to leaking of the toner 31.

### Second Embodiment

A second embodiment of the present invention will be explained next. Components same as those in the first embodiment are denoted by the same reference numerals, and explanations thereof are omitted. In the second embodiment, it is possible to attain a same effect associated with a structure same as that in the first embodiment.

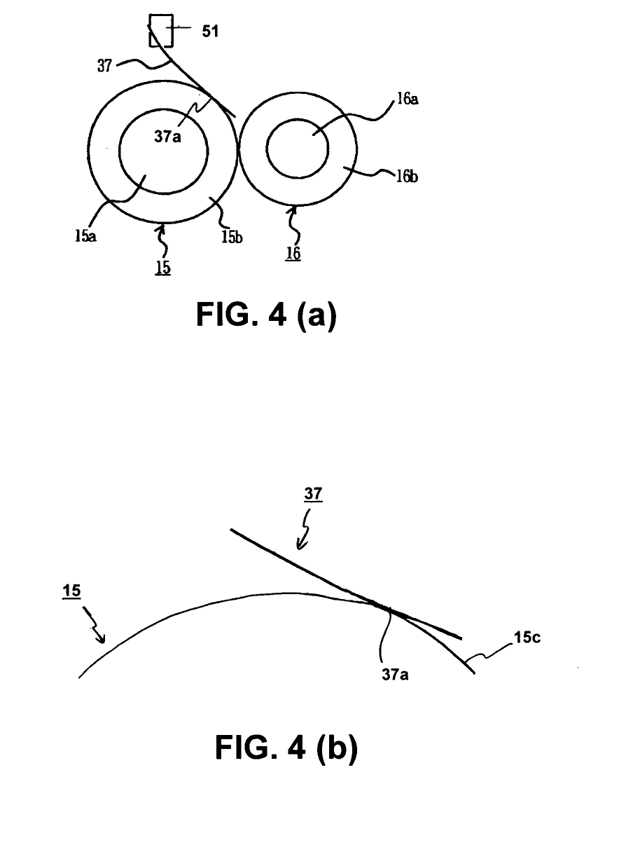

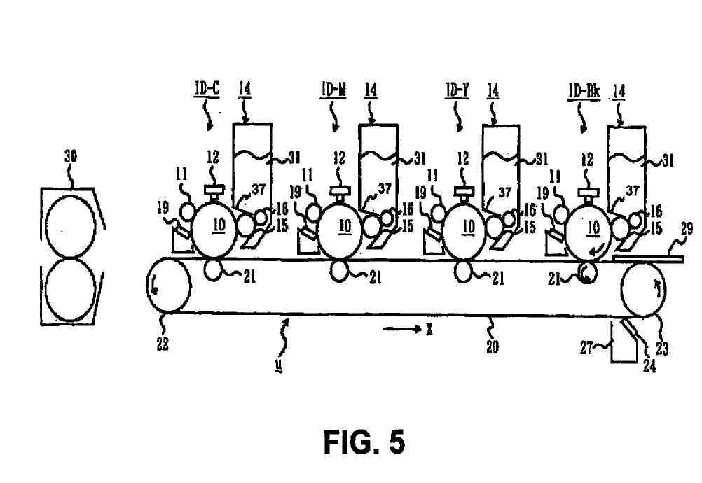

FIGS. 4(a) and 4(b) are schematic views showing a developing device according to the second embodiment of the present invention. FIG. 4(a) is a schematic view showing an overall structure of the developing device, and FIG. 4(b) is an enlarged view showing a contact point between the developing roller 15 and a layer controlling blade 37. FIG. 5 is a schematic view showing a printer according to the second embodiment of the present invention.

As shown in FIG. 4(a), the layer controlling blade 37 is formed of stainless steel (SUS 304) with elasticity, and has a thickness of 0.1 mm. The layer controlling blade 37 includes a portion formed in a flat plate shape and abutting against the developing roller 15. As shown in FIG. 4(b), the layer controlling blade 37 is arranged such that an outside surface 37a of the flat plate is pressed against the surface layer 15c (outermost layer of the developing roller 15). In the embodiment, the layer controlling blade 37 is arranged such that the developing roller 15 is pressed with a pressure in a range of 10 to 200 g/cm.

An experiment of finding an optimal range of the contact pressure will be explained next. In the experiment, the volume average particle diameter D (μm) of the toner 31 and the contact pressure P (g/cm) of the layer controlling blade 37 were changed. In the optimal range, there is no smear in printing a white sheet, and a darkness of 1.2 or higher is obtained in printing a whole black sheet, i.e., 100% darkness.

In the experiment, the charging characteristic of silica contained in the toner 31 (FIG. 5) as the outside additive; a pressure between the toner supplying roller 16 and the developing roller 15; and a voltage applied to the toner supplying roller 16 were also changed. With these changes, it was possible to change the average charge amount Q (μC/g) of the toner 31 on the developing roller 15 situated at a downstream side of the toner supplying roller 16 and an upstream side of the layer controlling blade 37. For the same reason as described above, in the experiment, toner having a volume average particle diameter smaller than 10 μm and greater than 5.2 μm was used.

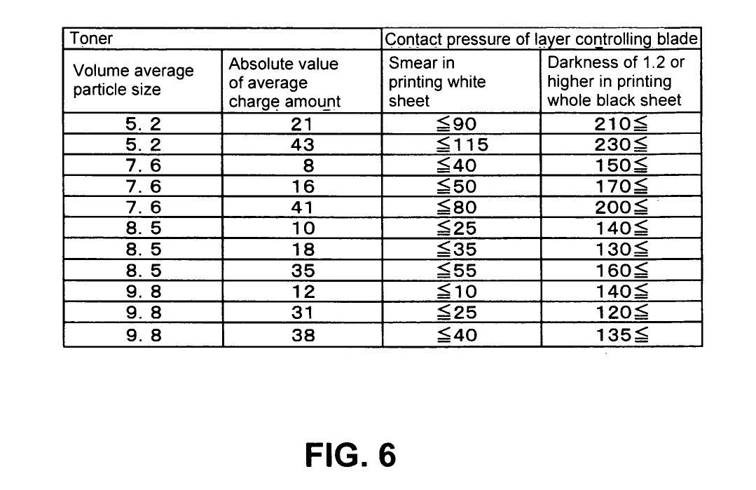

As shown in FIG. 6, when the volume average particle diameter D of the toner 31 decreases or the absolute value |Q| of the average charge amount Q increases, it is necessary to increase the contact pressure P of the layer controlling blade 37 for preventing smear on a white sheet. In contrast, when the volume average particle diameter D of the toner 31 increases or the absolute value |Q| of the average charge amount Q decreases, it is necessary to decrease the contact pressure P of the layer controlling blade 37 for obtaining a sufficient darkness in 100% printing.

Through the multiple regression analysis, a regression equation of the optimal range of the contact pressure P of the layer controlling blade 37 is obtained relative to the volume average particle diameter D of the toner 31 and the absolute value |Q| of the average charge amount Q as follows:
149.39−15.77×D+1.14×|Q|<P<293.74−18.97×D+0.82×|Q|

It is found that the regression equation has a contribution of 0.85 or greater, indicating high reliability.

Accordingly, in the embodiment, the contact pressure P of the layer controlling blade 37 is adjusted to be in the following range:
149.39−15.77×D+1.14×|Q|<P<293.74−18.97×D+0.82×|Q|
where D represents the volume average particle diameter of the toner 31, and |Q| represents the absolute value of the average charge amount Q of the toner 31 on the developing roller 15 before passing through the layer controlling blade 37. With the adjustment, a layer of the toner on the developing roller 15 is stabilized after passing through the layer controlling blade 37. Accordingly, it is possible to secure sufficient darkness of an image without causing smear on the image due to leaking of the toner 31.

As compared with the layer controlling blade 17 with the L-shaped portion in the first embodiment, the layer controlling blade 37 has the flat plate shape, thereby reducing manufacturing cost.

In the embodiments described above, the image forming apparatus is applied to the color printer of an electric photography type. The invention is also applicable to a developing device and an image forming apparatus of an electric photography type such as a monochrome printer and a copier using toner with a non-magnetic component.

The disclosure of Japanese Patent Application No. 2005-023853, filed on Jan. 31, 2005, is incorporated in the application.

While the invention has been explained with reference to the specific embodiments of the invention, the explanation is illustrative and the invention is limited only by the appended claims.

1. A developing device comprising:
a developer support member for supplying developer to an image supporting member to develop a static latent image;
a developer supplying member for charging the developer and supplying the developer to the developer support member; and
a layer controlling member abutting against the developer supply member for forming a thin layer of the developer, said layer controlling member being arranged such that the layer controlling member contacts with the developer supporting member with a contact pressure P (g/cm) according to a specific relationship relative to D and |Q|,
wherein D represents a volume average particle diameter (μm) of the developer; |Q| represents an absolute value of an average charge amount Q (μC/g) of the developer on the developer support member before the developer passes through the layer controlling member; and D is within a range of
5.2 μm≦D9.8 μm.

2. The developing device according to claim 1, wherein said layer controlling member is arranged such that the layer controlling member contacts with the developer supporting member with the contact pressure P within a range of
93.89−10.23×D+0.93×|Q|<P<184.91−13.09×D+1.15×|Q|.

3. The developing device according to claim 1, wherein said layer controlling member is arranged such that the layer controlling member contacts with the developer supporting member with the contact pressure P within a range of
149.39−15.77×D+1.14×|Q|<P<293.74−18.97×D+0.82×|Q|.

4. The developing device according to claim 2, wherein said layer controlling member includes a contact portion contacting with the developer supporting member, said contact portion having an L shape.

5. The developing device according to claim 3, wherein said layer controlling member includes a contact portion contacting with the developer supporting member, said contact portion having a flat plate shape.

6. The developing device according to claim 1, further comprising a contact pressure control unit for controlling the contact pressure of the layer controlling member against the developer supporting member.

7. An image forming device comprising the developing device according to claim 1.

8. A method of developing a static latent image, comprising the steps of:
charging developer;
supplying the developer to a developer supporting member; and
arranging a layer controlling member such that the layer controlling member contacts with the developer supporting member with a contact pressure P (g/cm) according to a specific relationship relative to D and |Q|,
wherein D represents a volume average particle diameter (μm) of the developer; |Q| represents an absolute value of an average charge amount Q (μC/g) of the developer on the developer support member before the developer passes through the layer controlling member; and D is within a range of
5.2 μm≦D≦9.8 μm.

9. The method of developing a static latent image according to claim 8, wherein, in the step of arranging the layer controlling member, said layer controlling member is arranged such that the layer controlling member contacts with the developer supporting member with the contact pressure P within a range of
93.89−10.23×D+0.93×|Q|<P<184.91−13.09×D+1.15×|Q|.

10. The method of developing a static latent image according to claim 8, wherein, in the step of arranging the layer controlling member, said layer controlling member is arranged such that the layer controlling member contacts with the developer supporting member with the contact pressure P within a range of
149.39−15.77×D+1.14×|Q|<P<293.74−18.97×D+0.82×|Q|.

11. The method of developing a static latent image according to claim 9, wherein, in the step of arranging the layer controlling member, said layer controlling member includes a contact portion contacting with the developer supporting member, said contact portion having an L shape.

12. The method of developing a static latent image according to claim 10, wherein, in the step of arranging the layer controlling member, said layer controlling member includes a contact portion contacting with the developer supporting member, said contact portion having a flat plate shape.

13. The method of developing a static latent image according to claim 8, wherein, in the step of arranging the layer controlling member, the layer controlling member is arranged with a contact pressure control unit for controlling the contact pressure of the layer controlling member against the developer supporting member.
